(19) United States
(12) Patent Application Publication
(10) Pub. No.: US 2017/0071229 A1
(43) Pub. Date: Mar. 16, 2017

(54) PROTEIN BASED FROZEN DESSERT USING ALTERNATIVE SUGARS AND METHODS OF MAKING THE SAME

(71) Applicant: COOLWHEY INC., Saint-Laurentt (CA)

(72) Inventor: Noah BERNETT, Montreal (CA)

(21) Appl. No.: 15/265,976

(22) Filed: Sep. 15, 2016

Related U.S. Application Data
(60) Provisional application No. 62/218,864, filed on Sep. 15, 2015.

(51) Int. Cl. A23G 9/38; A23G 9/32

(52) U.S. Cl. CPC A23G 9/38; A23G 9/327; A23G 9/32; A23V 2002/00

(57) ABSTRACT

The present document describes a process for the preparation of a protein-fortified frozen dessert formulation, which comprises the steps of mixing a first mix comprising water and a source of fat; mixing in the first mix a stabilizing agent, a sweetening agent, a first protein mix, to obtain a second mix, pasteurizing the second mix, cooling the second mix to produce a cooled second mix, adding a second protein mix into the cooled second mix, before, after, or before and after step cooling the second mix; ageing the cooled second mix to produce an aged mix; and freezing the aged mix to prepare the protein-fortified frozen dessert formulation.

### CROSS-REFERENCE TO RELATED APPLICATIONS

This application claims priority under 35USC§119(e) of U.S. provisional patent application 62/218,864, filed on Sep. 15, 2015, the specification of which is hereby incorporated by reference.

### BACKGROUND

(a) Field

The subject matter disclosed generally relates to processes for the preparation of a protein-fortified frozen dessert formulation, and products prepared therefrom.

(b) Related Prior Art

Frozen desserts are typically formulated to a protein level of 2-4 percent weight per volume (% w/v). Protein fortification to higher levels presents significant processing challenges, in that product mixes become excessively viscous and, consequently, difficult to pump and heat-process. Furthermore, in such products, the high level of protein may cause the mixture to coagulate, resulting in a loss of desired texture and creating difficulties in the freezing process.

There are various examples in the art of attempts at creating a protein fortified yogurt. For example, U.S. Pat. No. 4,837,036 to Baker et al. discloses a low fat thin-bodied yogurt that has high protein content. However, such a formulation is not likely to result in a finished product with a creamy texture/mouthfeel and taste. U.S. Pat. No. 4,258,064 to Michener, Jr. discloses preparation of a non-fat naturally sweet yogurt and discloses that one object of the invention is to provide a high protein, low calorie yogurt product but does not describe the formulation used to achieve this. U.S. Pat. No. 4,110,476 to Rhodes discloses the preparation of both liquid and frozen yogurt products. The process used to produce this formulation first creates a liquid yogurt, which is designed to be a beverage, which optionally can be frozen into a soft-serve yogurt. Rhodes' method relies on the use of microcrystalline cellulose to stabilize the blend. The inclusion of microcrystalline cellulose may be perceived as undesirable by health conscious consumers. US Patent Publication No. 2005/0129835 to Delahanty discloses high protein content food supplement which can be modified to a frozen yogurt. This product is designed to be a supplement and contains protein at undesirably high levels that would not offer the desired flavour of a frozen yogurt dessert. Contrary to what the patent states, frozen yogurt formulations with this level of whey protein, particularly hydrolyzed whey protein, are likely to have a bitter, objectionable flavour. Furthermore, this formula is likely to result in a highly viscous product that is difficult to pasteurize using traditional pasteurization methods. A mix that is this viscous will wear out pumps, mixers, etc. There is likely to be product build-up & burn on during batch or continuous pasteurization. A product that is this thick is likely to entrain air which would likely lead to pumping problems. According to this patent, a sponge or dough is formed by wetting the dry ingredients with just enough water to result in this consistency; this method requires the use of high torque mixers not commonly found in frozen novelty manufacturing plants. A mixing time of 20 minutes, as described, is not a good fit for high volume production facilities where speed and efficiency of mix preparation is critical.

In view of the foregoing, there remains a need in the art to create a protein-fortified frozen dessert formulation designed for making a frozen dessert product.

### SUMMARY

According to an embodiment, there is provided a process for the preparation of a protein-fortified frozen dessert formulation comprising:
a) mixing a first mix comprising water and a source of fat;
b) mixing in the first mix a stabilizing agent, a sweetening agent, a first protein mix, to obtain a second mix;
c) pasteurizing the second mix;
d) cooling the second mix to produce a cooled second mix;
e) adding a second protein mix into the cooled second mix, before, after, or before and after step d);
f) ageing the cooled second mix to produce an aged mix;
g) freezing the aged mix to prepare the protein-fortified frozen dessert formulation,
   wherein
the water may be about 40-60% (w/w) of the aged mix,
the source of fat may be about 0-20% (w/w) of the aged mix,
the stabilizing agent may be about 0-1.5% (w/w) of the aged mix,
the sweetening agent may be about 0-35% (w/w) of the aged mix,
the first protein mix may be about 2-13% (w/w) of the aged mix,
the second protein mix may be 2.5-25% (w/w) of the aged mix, and
the flavoring agent may be 0-20% (w/w) of the aged mix.

The step b) may further comprise mixing in a flavoring agent.

The step c) may further comprise subjecting the second mix to two stage pressure homogenization.

The source of fat may include a pasteurized cream, an unpasteurized cream, a biological cream, a processed cream, a coconut cream, a standardized cream, an unstandardized cream, a pasteurized milk, an unpasteurized milk, a milk fat solid, a coconut milk, a buttermilk, a buttermilk solids, a dairy based solid, a non-dairy based solid, a butter based fat, an omega fatty acids, a palm oil, a corn oil, and a rapeseed oil, or combinations thereof.

The suitable stabilizing agents may comprise gelatin, pectin, calcium chloride, lecithin, mono and diglycerides, monoglyceride derivatives, fatty acid derivatives, guar gum, gum arabic, tara gum, acacia, acetan, acetylated distarch phosphate, acetylated starch, acid-thinned starch, adipic starch, agar (agar-agar), agaropectin, agarose, algin, alginate, alginic acid, amidated pectins, amorphophallus, amylopectin, amylopectin starch, amylose, arabic, arabica, arabinogalactan, arabogalactan, arracacha, arrowroot, beet pulp, beta glucan, bevo, blood, british gum, cactus gum, carboxymethyether starches, carboxymethylcellulose, carboxymethylmethylcellulose, carboxymethyl starch, carob, caseins, caseinates, cassia, chitin, chitosan, clay, collagen, combretum, curdlan, cyclodextrin, cydonia, danish agar, dextran, dextrin, dulsan, distarch phosphate, ethylcellulose, ethylhydroxyethylcellulose, ethylmethylcellulose, eucheumas, ferlo, fibres, fibrinogen, flax seed, fucoidan, furcelleran, funoran, galactomannans, gatto, gelidium, gellan gum, ghatti, gigartinas, globulins, glucomannans, glues, gluten, gracilarias, guluronics, gummifera, hashab, hemicelluloses, high amylose starch, hoblobo, hydrogenated starch, hydroxyalkylcellulose, hydroxyalkyl starch, hydroxyethylcellulose, hydroxyethylmethylcellulose, hydroxypropylcellulose, hydroxypropylmethylcellulose, hydroxypropyl starch, hypnean, iridaeans, isinglass, karaya, karroo, kelp, keltzan, konjac, kordofan, lakee, lambda carrageenan, laminaran, larch, latex, linseed, locust bean gum, lupo, luposol, maltodextrin, mannan, mannoglucuronoglycans, mannuronics, maracuya, mesquite, methylcellulose, microcrystalline cellulose, mucilage, mucin, mung bean, okra, ovalbumins, oxidised starch, pea starch, pectic acid, plant exudates, plasma, porphyran, potato pulp, potato starch, pregelatinized starches, proatrim, propylated starch, propylene glycol alginate, prosopsis seed, prosopsis, exudate, protopectins, prowashonupana barley, pulcherima, pullulan, psyllium, pyrodextrins, quince, quince seed, ramalin, rhamsam, rice products, st. johns bread, salabreda, sandra beida, schizophyllan, scleroglycan, seaweed powders, semen cydonia, senna, seyal, sorghum, soy protein, sterculia, suakim, succinoglycan, sunflower pectin, sunt, tahl, tahla, tamarind seed, tamarind kernel, taminda, tapioca, tara, tragacanth, undaria, verek, wattles, waxy maize, waxy rice, waxy sorghum, wheat products, whey protein, xyloglucan, yeast cell walls, gelatin, iota carrageenan, kappa carrageenan, a pectin, a powdered cellulose, sodium alginate, xanthan gum, and combinations thereof.

The sweetening agent may comprises, glucose, fructose, sucrose, xylitol or any other polyalchohol such as arabitol, erythritol, glycerol, hydrogenated starch hydrolysates (HSH), isomalt, lactitol, maltitol, mannitol, sorbitol, ethylene glycol, threitol, ribitol, galactitol, fucitol, iditol, inositol, volemitol, maltotrital, maltotetraitol, polyglycitol, mongrosides, as well as other sugar alternatives such as aspartame, agave, stevia, coconut sugar, date sugar, acesulfame K, cyclamate, saccharin, sucralose, or combinations thereof.

The first or the second protein mix may comprise whey protein, a milk protein, a casein, an albumin, a vegetable protein, soy protein, a whey protein concentrate, a whey protein isolate, a hydrolyzed whey protein, a milk protein concentrate, a milk protein isolate, a hydrolyzed milk protein, a soy protein concentrate, a soy protein isolate, a hydrolyzed soy protein, a heat stable whey protein, a whey concentrate, an egg white protein, a rice protein, a pea protein, a hemp protein, an insect based protein powder, and combinations thereof.

The flavoring agents may comprise a cocoa powder, a chocolate, a chocolate chips, a flavor providing powder, a liquid flavor, a maple syrup, a maple sap, a fruit flavoring, a vanilla flavor, a caramel, peanut butter, bubble-gum, nuts, fruits, vegetables, cookies, brownies, pie crust pieces, wafer pieces, sugar cone pieces; cookie dough; candies; chocolate bar pieces; crunches, jams, purees, and combinations thereof.

The fruit flavoring may comprise orange, apple, grapefruit, pineapple, strawberry, raspberry, cranberry, lime, lemon, grape, peach, cherry flavor, and combinations thereof.

The step b) may be with a high sheer mixer, or a high speed tank blender.

The step b) may be at from about 35° C. to about 60° C.

The step c) of pasteurizing may be at from about 70° C. to 71° C. for 30 minutes.

The two stage pressure homogenization may comprise a first stage at from about about 6.9 Mpa to about 17.2 Mpa, and a second stage at 3.4 Mpa to about 6.9 Mpa.

The two stage pressure homogenization may comprise a first stage at from about about 10.3 Mpa to about 17.2 Mpa, and a second stage at 3.4 Mpa to about 6.9 Mpa.

The two stage pressure homogenization may comprise a first stage at from about about 13 Mpa to about 14 Mpa, and a second stage at 3.4 Mpa to about 6.9 Mpa.

The step d) of cooling may be to about 2° C. to about 5° C.

The step f) of ageing may be for about 2 to about 10 hours.

The second protein mix, flavoring agent, or both may be provided as pre-pasteurized.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### DETAILED DESCRIPTION

The present invention provides a protein-fortified frozen dessert formulation and process for making protein-fortified frozen dessert food products.

The formulations of the present invention have been fortified with protein, resulting in a total protein content of 5 to 35% w/w. The term “protein fortified frozen dessert” as used herein is understood to mean having a final protein content of at least 5% w/w, preferably in the range of 10-25% w/w, and up to 35% w/w, or from about 5% to about 35%, or about 10% to about 35%, or about 15% to about 35%, or about 20% to about 35%, or about 25% to about 35%, or about 30% to about 35%, or from about 5% to about 30%, or about 10% to about 30%, or about 15% to about 30%, or about 20% to about 30%, or about 25% to about 30%, or from about 5% to about 25%, or about 10% to about 25%, or about 15% to about 25%, or about 20% to about 25%, or from about 5% to about 20%, or about 10% to about 20%, or about 15% to about 20%, or from about 5% to about 15%, or about 10% to about 15%, or from about 5% to about 10%. The person skilled in the art would appreciate that the total protein content can be calculated from the protein components, and any other protein source used in the preparation of the frozen dessert of the present invention, such as for example the protein content of cream, milk, milk solids and other component of the final product.

In embodiments there is disclosed a process for the preparation of a protein-fortified frozen dessert formulation comprising the following steps:
a) mixing a first mix comprising water and a source of fat;
b) mixing in the first mix a stabilizing agent, a sweetening agent, a first protein mix, to obtain a second mix;
c) pasteurizing the second mix;
d) cooling the second mix, to produce a cooled second mix;
e) adding a second protein mix into the cooled second mix before, after, or before and after step d);
f) ageing the cooled second mix to produce an aged mix;
g) freezing the aged mix to prepare the protein-fortified frozen dessert formulation,
   wherein
the water is about 40-60% (w/w) of the aged mix,
the source of fat is about 0-20-20% (w/w) of the aged mix,
the stabilizing agent is about 0-1.5% (w/w) of the aged mix,
the sweetening agent is about -35% (w/w) of the aged mix,
the first protein mix is about 2-13% (w/w) of the aged mix,
the second protein mix is 2.5-25% (w/w) of the aged mix, and
the flavoring agent is 0-20% (w/w) of the aged mix.

According to an embodiment, in the first step of the process, water (40-60% w/w of the total formulation, also referred to as the aged mix above) is mixed with a source of fat (0-20% w/w of the total formulation) in the preparation of a first mix. The source of fat includes, without limitations cream, of the pasteurized or unpasteurized nature, including but not limited to biological cream, processed cream, coconut cream, standardized cream, unstandardized cream and any other type of cream that contains milk fat and is acceptable in use for all types of ice-cream or frozen dessert foods in North America or the world. The source of fat may also be milk (also of the pasteurized or unpasteurized nature), milk fat solids, coconut milk, buttermilk or buttermilk solids, and any other type of dairy or non-dairy based solids that are permitted in any type of ice cream or frozen dessert in North America. The source of fat may also be butter based fats, or alternative based fats, such as omega fatty acids, Omega fatty acids may be derived from canola oil, flax seed oil, flax powder, flax seeds, olive oil, walnut oil, soybean oil and fish oils. Also included in alternative based fats are palm oils, corn oils, and rapeseed oils. The source of fat comprises about 0%-20% w/w, or about 0%-15% w/w, or about 0%-10% w/w, or about 0%-5% w/w, 5%-20% w/w, or about 5%-15% w/w, or about 5%-10% w/w, or 10%-20% w/w, or about 10%-15% w/w, or 15%-20% w/w of the total formulation, but other ingredients may also contribute to the total fat content of the final product, such that percentage of fats in the resulting final product may be higher than 20% w/w.

After the ingredients of the first mix have been homogenized, stabilizing agents, sweetening agents, a first protein mix, and optionally a flavoring agent are added to the first mix to provide a second mix.

In embodiments, suitable stabilizing agents include but are not limited to Gelatin, Pectin, Calcium Chloride, Lecithin, Mono and diglycerides, Monoglyceride derivatives, Fatty Acid derivatives, Guar Gum, Gum Arabic, Tara Gum, acacia, acetan, acetylated distarch phosphate, acetylated starch, acid-thinned starch, adipic starch, agar (agar-agar), agaropectin, agarose, algin, alginate, alginic acid, amidated pectins, amorphophallus, amylopectin, amylopectin starch, amylose, arabic, arabica, arabinogalactan, arabogalactan, arracacha, arrowroot, beet pulp, beta glucan, bevo, blood, british gum, cactus gum, carboxymethyether starches, carboxymethylcellulose, carboxymethylmethylcellulose, carboxymethyl starch, carob, caseins, caseinates, cassia, chitin, chitosan, clay, collagen, combretum, curdlan, cyclodextrin, cydonia, danish agar, dextran, dextrin, dulsan, distarch phosphate, ethylcellulose, ethylhydroxyethylcellulose, ethylmethylcellulose, eucheumas, ferlo, fibres, fibrinogen, flax seed, fucoidan, furcelleran, funoran, galactomannans, gatto, gelidium, gellan gum, ghatti, gigartinas, globulins, glucomannans, glues, gluten, gracilarias, guluronics, gummifera, hashab, hemicelluloses, high amylose starch, hoblobo, hydrogenated starch, hydroxyalkylcellulose, hydroxyalkyl starch, hydroxyethylcellulose, hydroxyethylmethylcellulose, hydroxypropylcellulose, hydroxypropylmethyl-cellulose, hydroxypropyl starch, hypnean, iridaeans, isinglass, karaya, karroo, kelp, keltzan, konjac, kordofan, lakee, lambda carrageenan, laminaran, larch, latex, linseed, locust bean gum, lupo, luposol, maltodextrin, mannan, mannoglucuronoglycans, mannuronics, maracuya, mesquite, methylcellulose, microcrystalline cellulose, mucilage, mucin, mung bean, okra, ovalbumins, oxidised starch, pea starch, pectic acid, plant exudates, plasma, porphyran, potato pulp, potato starch, pregelatinized starches, proatrim, propylated starch, propylene glycol alginate, prosopsis seed, prosopsis, exudate, protopectins, prowashonupana barley, pulcherima, pullulan, psyllium, pyrodextrins, quince, quince seed, ramalin, rhamsam, rice products, St. Johns bread, salabreda, sandra beida, schizophyllan, scleroglycan, seaweed powders, semen cydonia, senna, seyal, sorghum, soy protein, sterculia, suakim, succinoglycan, sunflower pectin, sunt, tahl, tahla, tamarind seed, tamarind kernel, taminda, tapioca, tara, tragacanth, undaria, verek, wattles, waxy maize, waxy rice, waxy sorghum, wheat products, whey protein, xyloglucan, yeast cell walls, gelatin, iota carrageenan, kappa carrageenan, a pectin, a powdered cellulose, sodium alginate, xanthan gum, and combinations thereof. In embodiments, the stabilizing agent is present in the formulation of the present invention at about 0-1.5% (w/w), or about 0-1.0% (w/w), or about 0-0.5% (w/w), or about 0-0.25% (w/w), 0.25-1.5% (w/w), or about 0.25-1.0% (w/w), or about 0.25-0.5% (w/w), or about 0.5-1.5% (w/w), or about 0.5-1.0% (w/w), or about 1-1.5% (w/w) of the total formulation.

In embodiments, the sweetening agents include but are not limited to glucose (D-Glucose, dextrose), fructose, sucrose, xylitol or any other polyalchohol such as arabitol, erythritol, glycerol, Hydrogenated starch hydrolysates (HSH), isomalt, lactitol, maltitol, mannitol, sorbitol, ethylene glycol, threitol, ribitol, galactitol, fucitol, iditol, inositol, volemitol, maltotrital, maltotetraitol, polyglycitol, mongrosides, as well as other sugar alternatives such as aspartame, agave, stevia, coconut sugar, date sugar, acesulfame K, cyclamate, saccharin, sucralose, or combinations thereof, at a percentage of about 0% to about 35% w/w, or about 0% to about 30%, or about 0% to about 25%, or about 0% to about 20%, or about 0% to about 15%, or about 0% to about 10%, or about 0% to about 5%, or about 5% to about 35% w/w, or about 5% to about 30%, or about 5% to about 25%, or about 5% to about 20%, or about 5% to about 15%, or about 5% to about 10%, or about 10% to about 35% w/w, or about 10% to about 30%, or about 10% to about 25%, or about 10% to about 20%, or about 10% to about 15%, or about 15% to about 35% w/w, or about 15% to about 30%, or about 15% to about 25%, or about 15% to about 20%, or about 20% to about 35% w/w, or about 20% to about 30%, or about 20% to about 25%, or about 25% to about 35% w/w, or about 25% to about 30%, or about 30% to about 35% w/w of the total formulation.

In embodiments, the first protein mix includes any proteins. The protein may be selected from whey protein, milk protein, casein, albumin, vegetable protein and soy protein. In one embodiment, the whey protein is whey protein concentrate, whey protein isolate or hydrolyzed whey protein. In another embodiment, the milk protein is milk protein concentrate, milk protein isolate or hydrolyzed milk protein. In yet another embodiment, the soy protein is soy protein concentrate, soy protein isolate or hydrolyzed soy protein. According to another embodiment, the protein may be, without limitations, heat stable whey protein, whey concentrate, egg white protein, soy protein, rice protein, pea protein, hemp protein, cricket or other insect based protein powder, and modified mixtures of any one of the protein types enumerated above. As used herein regarding protein, modified is intended to mean proteins preparations having modified pH compared to their natural counterparts, proteins preparations having moisture content different than their natural counterparts. The present invention also encompasses combinations of any one of the protein preparations. The first protein mix is used at a percentage of 2% to 13% w/w of the final mix.

A person skilled in the art would understand that if the protein ingredient in above is at 0%, the formulation would be protein-fortified by using the upper ranges of the milk solids for example, which would provide the necessary protein content.

A person skilled in the art would understand that whey is the by-product of the cheese-making process. Whey protein concentrate is manufactured by filtering out significant quantities of lactose, minerals and water from whey by means of an ultrafiltration process resulting in a protein concentrated liquid that is then spray dried into a powder form. Hydrolyzed whey protein, also referred to as whey protein hydrolysate, is produced by a controlled enzymatic treatment of whey prior to further processing resulting in a specific amino acid/peptide/polypeptide profile.

In embodiment, optionally, flavoring agents may be added to the first mix. These include without limitations powders, which include cocoa powders, or chocolates and or other types of flavor providing powders. Flavoring agent may also be liquid flavors of the natural or unnatural variety, such as maple syrup, maple sap, fruit flavoring such as orange, apple, grapefruit, pineapple, strawberry, raspberry, cranberry, lime, lemon, grape, peach, cherry, or other flavoring such as vanilla, and chocolate, and caramel, as well as flavor ingredients such as pasteurized or unpasteurized berries, or other such as natural peanut butter, chocolate chips, caramel, bubble-gum, a variety of nuts, fruits and vegetables and baked inclusions such as cookies, brownies, pie crust pieces, wafer pieces, sugar cone pieces; cookie dough; candies; chocolate bar pieces; crunches, jams, purees, and any other type of raw ingredient. Flavoring agents may be added at a percentage of about 0% to about 20% w/w, or from about 0% to about 15%, or from about 0% to about 10%, or from about 0% to about 5%, or about 5% to about 20% w/w, or from about 5% to about 15%, or from about 5% to about 10%, or about 10% to about 20% w/w, or from about 10% to about 15%, or about 15% to about 20% w/w of the total formulation.

The ingredients may be added to the first mix in order to provide a second mix. All the ingredients are incorporated in the first mix and thoroughly mixed at high speed and power, for example using a high sheer mixer, or a high speed tank blender such as a triblender, or a low shear Jet mixer or a low shear Jet mixer such as the Quadro Ytron® Jet Mixer to obtain the second mix having the desired texture and consistency expected of the final product. According to an embodiment, the provided second mix may be a well-mixed and relatively, yet not completely homogenous mix, where small pieces of the ingredients added to the first mix remain. According to another embodiment, the second mix may be a well-mixed, yet non-homogenous mix, where chunks and pieces of the added ingredients (such as pieces of chocolate, fruit, or the likes) may remain in the mixtures. According to yet another embodiment, the second mix may be a well-mixed, homogenous mix. Mixing as such is necessary to ensure proper dissolution of the high protein content of the second mix, and avoid coagulation of the protein, despite the high viscosity of the second mix afforded by such atypically high protein content.

According to an embodiment, the step of mixing in the stabilizing agent, a sweetening agent, a first protein mix, and optionally the flavoring agents, to obtain a second mix may be performed at an appropriate temperature for appropriate mixing, dissolution, blending and/or homogenization. According to an embodiment, the step may be performed at temperatures of about 35° C. to about 60° C., or about 37° C. to about 60° C., or about 40° C. to about 60° C., or about 42° C. to about 60° C., or about 45° C. to about 60° C., or about 48° C. to about 60° C., or about 50° C. to about 60° C., or about 55° C. to about 60° C.

Following the second step of mixing and blending or homogenizing of the ingredients, as may be required by the desired final texture, the second mix is brought to the third step—pasteurization of the second mix. According to an embodiment, to do so all of the ingredients of the second mix are brought to an appropriate temperature of pasteurization. The term “pasteurization” as used herein means the process of heating food for the purpose of killing harmful organisms such as bacteria, viruses, protozoa, molds and yeast. In one embodiment, pasteurizing is by batch pasteurization or continuous pasteurization. Temperatures for pasteurization of milk ingredients are typically below boiling point. There is not a range per se that needs to be used but rather a time/temperature continuum—as the temperature increases the hold time decreases and vice versa. In a particular embodiment, batch pasteurization is at 69° C. for 30 minutes or any other temperature and time combination that results in the product being pasteurized. In another embodiment, batch pasteurization is at 70-71° C. for 30 minutes. In another particular embodiment, continuous pasteurization is at 80° C. for 25 seconds or any other temperature and time combination that results in the product being pasteurized. In other embodiment, pasteurization may be high temperature short time pasteurization (HTST) at about 72° C. for about 15 to 45 seconds, ultra-heat-treating (UHT) 144° C. for about 4 to 10 seconds. According to another embodiment, pasteurization may also be achieved by heating in the range of 63° C. to about 75° C., for about 30 minutes, depending upon the composition of the mixture of the present invention being treated. Step 3 is subject to variations depending on the type of pasteurization being used.

Pursuant to pasteurization, the second mix may be optionally subjected to a two stage homogenization process where the second mix subjected to pressure homogenization (PH). According to an embodiment, the two stage homogenization step is based on a two stage homogenizer. For example, the homogenizer may have two stages homogenization valves. According to some embodiments, the combined homogenization of the two stages may be from about 13.79 Mpa (2000 PSI) to about 24.13 Mpa (3500 PSI). According to an embodiment, the first stage may be carried out at about 6.9 Mpa (1000 PSI) to about 17.2 Mpa (2500 PSI), or about 10.3 Mpa (1500 PSI) to about 17.2 Mpa (2500 PSI), or about 10.3 Mpa (1500 PSI) to about 13.7 Mpa (2000 PSI), or about 13 Mpa (about 1885 PSI) to about 14 Mpa (about 2025 PSI) or about 13.7 Mpa (about 2000 PSI). According to another embodiment, the second stage may be carried out at about 3.4 Mpa (about 500 PSI) to about 6.9 Mpa (about 1000 PSI), or about 5.1 Mpa (about 750 PSI) to about 6.9 Mpa (about 1000 PSI), or about 3.4, or 5.1, or 6.9 Mpa (about 500, 750, or 6.9 PSI).

Following the pasteurization and/or the two stage homogenization, the second mix may be rapidly cooled to about 2° C. to about 5° C., to produce a cooled second mix. At this point, before, after, or before and after the step of cooling the second mix, a second protein mix may be added to the second mix. Like the first protein mix, the second protein mix includes without limitations whey protein isolate, heat stable whey protein, whey concentrate casein or milk protein, egg white protein, soy protein, rice protein, pea protein, hemp protein, cricket or other insect based protein powder, and modified mixtures of any one of the protein types enumerated above. As used herein regarding protein, modified is intended to mean proteins preparations having modified pH compared to their natural counterparts, proteins preparations having moisture content different than their natural counterparts. The present invention also encompasses combinations of any one of the protein preparations. The second protein mix is used at a percentage of about 2% to about 25% w/w, or about 2% to about 20% w/w, or about 2% to about 15% w/w, or about 2% to about 12.5% w/w, or about 2% to about 10% w/w, or about 2% to about 7.5% w/w, or about 2% to about 5% w/w, or about 2% to about 2.5% w/w, or about 2.5% to about 25% w/w, or about 2.5% to about 20% w/w, or about 2.5% to about 15% w/w, or about 2.5% to about 12.5% w/w, or about 2.5% to about 10% w/w, or about 2.5% to about 7.5% w/w, or about 2.5% to about 5% w/w, or about 5% to about 25% w/w, or about 5% to about 20% w/w, or about 5% to about 15% w/w, or about 5% to about 12.5% w/w, or about 5% to about 10% w/w, or about 5% to about 7.5% w/w, or about 7.5% to about 25% w/w, or about 7.5% to about 20% w/w, or about 7.5% to about 15% w/w, or about 7.5% to about 12.5% w/w, or about 7.5% to about 10% w/w, or about 10% to about 25% w/w, or about 10% to about 20% w/w, or about 10% to about 15% w/w, or about 10% to about 12.5% w/w, or about 12.5% to about 25% w/w, or about 12.5% to about 20% w/w, or about 12.5% to about 15% w/w, or about 15% to about 25% w/w, or about 15% to about 20% w/w, or about 20% to about 25% w/w of the final mix. The second protein mix is normally provided as pre-pasteurized protein or conform to the health standards imposed by either CFIA or FDA in post pasteurization ingredients as described in the Ice Cream and/or frozen dessert regulations, such that the final product will not be contaminated by this addition of protein. A person skilled in the art would understand that post pasteurization, only ingredients that have been pre-screened and certified, by lot code, as having met established microbial, physical and compositional standards that ensure finished product safety and performance should be used.

According to another embodiment, optionally, flavoring agents may be added to the second mix. These include without limitations powders, which include cocoa powders, or chocolates and or other types of flavor providing powders. Flavoring agent may also be liquid flavors of the natural or unnatural variety, such as maple syrup, maple sap, fruit flavoring such as orange, apple, grapefruit, pineapple, strawberry, raspberry, cranberry, lime, lemon, grape, peach, cherry, or other flavoring such as vanilla, and chocolate, and caramel, as well as flavor ingredients such as pasteurized or unpasteurized berries, or other such as natural peanut butter, chocolate chips, caramel, bubble-gum, a variety of nuts, fruits and vegetables and baked inclusions such as cookies, brownies, pie crust pieces, wafer pieces, sugar cone pieces; cookie dough; candies; chocolate bar pieces; crunches, jams, purees, and any other type of raw ingredient. Flavoring agents may be added at a percentage of about 0% to about 20% w/w, or from about 0% to about 15%, or from about 0% to about 10%, or from about 0% to about 5%, or about 5% to about 20% w/w, or from about 5% to about 15%, or from about 5% to about 10%, or about 10% to about 20% w/w, or from about 10% to about 15%, or about 15% to about 20% w/w of the total formulation. Again, the flavoring agent added to the second mix are normally provided as pre-pasteurized ingredient or conform to the health standards imposed by either CFIA or FDA in post pasteurization ingredients as described in the Ice Cream and/or frozen dessert regulations, such that the final product will not be contaminated by this addition of protein. A person skilled in the art would understand that post pasteurization, only ingredients that have been pre-screened and certified, by lot code, as having met established microbial, physical and compositional standards that ensure finished product safety and performance should be used.

Again, all the ingredients are thoroughly mixed, blended, or even homogenized, as may be required by the desired final texture of the product prepared, and to emulsify the whole ingredients, at high speed and power. According to an embodiment, the provided cooled second mix may be a well-mixed and relatively, yet not completely homogenous mix, where small pieces of the ingredients added to the first mix remain. According to another embodiment, the cooled second mix may be a well-mixed, yet non-homogenous mix, where chunks and pieces of the added ingredients (such as pieces of chocolate, fruit, or the likes) may remain in the mixtures. According to yet another embodiment, the cooled second mix may be a well-mixed, homogenous mix. For example, this may be achieved using a high sheer mixer, such as sanitary stainless steel shear pumps, or high shear powder liquid mixers, triblenders, or a low shear Jet mixer such as the Quadro Ytron® Jet Mixer or any other suitable blending devices capable of mixing in the supplemental protein content. Typically, such blending devices may be operated at about 1500 RPM to about 12000 RPM as may be necessary to achieve emulsification/introduction of the second protein mix therein. Mixing as such is necessary to ensure proper dissolution of the high protein content of the cooled second mix, and avoid coagulation of the protein, despite the high viscosity of the second mix afforded by such atypically high protein content.

Following cooling and the addition of the second protein mix, the cooled second mix is aged for 2 to 10 hours to produce an aged mix, in order for the stabilizing agent or agents, proteins and other ingredients to age correctly. As used herein, the terms “age” or “aging” is intended to at least encompass the process of hydration and moisture absorption by the proteins and stabilizing agents present in the protein-fortified frozen dessert formulation of the present invention.

In another embodiment, the aged mix is then pumped from the mix tank in an unfrozen state, pumped through an ice cream maker, and directly inserted in appropriate containers or be used for the preparation of ice cream bars, popsicles, or the likes, which are frozen and stored.

Therefore, in embodiments there is disclosed a protein-fortified frozen dessert prepared by the process of the present invention.

The present invention will be more readily understood by referring to the following examples which are given to illustrate the invention rather than to limit its scope.

### EXAMPLE 1

### Preparation of a Frozen Dessert No. 1

In a pasteurization tank add 931.4 kg of water and 178.7 kg of 37% standardized unpasteurized cream. This accounts for 67.3% w/w of the entire final mix. The first mix is agitated until blended.

With a Tri-blender™ or Sheer blender (or any other mixing apparatus) add 165 kg of Xylitol (10% w/w of entire final mix), 9.075 kg of stabilizing agent (Guar Gum, Locust Bean gum, Gum Arabic, and Carrageenan—0.55% w/w of the entire final mix), 68.8kg of Thermax brand Heat stable Protein Concentrate (70% purity) (about 4.2% w/w of the entire final mix). It is believed that in general, it is preferable to add about 2-6% protein before pasteurization. Other flavouring components are also introduced at this stage, for example flavoring agents, salts, citric acid, strawberry puree, cocoa powder, peanut butter, as may be required for the particular blend of ice cream being prepared.

All of the above ingredients are then brought to a temperature of pasteurization of about 63° C. to about 75° C., commonly 71° C. and kept at this temperature for 30 minutes.

The mix is then sent through a two stage homogenizer and then a plate cooler for the mix to achieve a temperature of 2° C. to 5° C.

Following the preparation of the cooled second mix above, 297 kg of Mullins Brand™ 90/30 (90% purity) (18% w/w of the entire final mix) Whey Protein Isolate is introduced by shear blending (with either inline shear blending or outline sheer blending) into the cooled second mix. Color additives are then added as necessary.

The mix is then frozen using any type of ice cream machine that is permitted in Ice Cream and/or frozen dessert manufacturing.

The Ice Cream is then cupped into our 180 ml cups and stocked into boxes that hold 24 units of each. Each cup of 180 ml has 120 g of product in it.

### EXAMPLE 2

### Preparation of a Frozen Desert No. 2 (High Fat)

In a pasteurization tank add 398.05 kg of water and 258.00 kg of 37% standardized unpasteurized cream. This accounts for 65.605% w/w of the entire final mix. The first mix is agitated until blended.

With a Tri-blender™ or Sheer blender (or any other mixing apparatus) add 55 kg of erythritol (5.5% w/w of entire final mix), 3.5 kg of stabilizing agent (Guar Gum, Locust Bean gum, and Carrageenan—0.35% w/w of the entire final mix), 12.5 kg of Milk Protein Concentrate (70% purity) (1.25% w/w of entire final mix), 80 kg skim milk powder (8% w/w of entire final mix), 30 kg of sugar (3% w/w of entire final mix), 60 kg inulin (6% w/w of entire final mix), 0.450 kg of steviol glycosides (0.045% w/w of entire final mix). It is believed that in general, it is preferable to add about 0-6% protein before pasteurization. Other flavouring components may also be introduced at this stage or reserved for later addition, for example masking agents, salts, citric acid, strawberry puree, cocoa powder, peanut butter, as may be required for the particular blend of ice cream being prepared.

All of the above ingredients are then brought to a temperature of pasteurization of about 63° C. to about 75° C., commonly 71° C. and kept at this temperature for 30 minutes.

The mix is then sent through a plate cooler for the mix to achieve a temperature of 2° C. to 5° C.

Following the preparation of the cooled second mix above, 102.5 kg of whey protein isolate (90% purity) (10.25% w/w of the entire final mix). The whey protein Isolate is introduced by shear blending (with either inline shear blending or outline sheer blending) into the cooled second mix. Other methods of blending may also be used, although sheer blending is preferred. Color additives and flavoring components are then added as necessary.

The mix is then frozen using any type of ice cream machine that is permitted in ice cream and/or frozen desert manufacturing.

The ice cream is then cupped into 500 ml cups and stocked into boxes. Each cup of 500 ml has 300 grams of product in it.

### EXAMPLE 3

### Preparation of a Frozen Desert No. 3 (New Sport)

In a pasteurization tank add 454.8 kg of water and 163.8 kg of 37% standardized unpasteurized cream. This accounts for 61.86% w/w of the entire final mix. The first mix is agitated until blended.

With a Tri-blender™ or sheer blender (or any other mixing apparatus) add 45 kg of erythritol (4.5% w/w of entire final mix), 3.5 kg of stabilizing agent (guar gum, locust bean gum, and carrageenan—0.35% w/w of the entire final mix), 30 kg of milk protein concentrate (70% purity) (3.0% w/w of entire final mix), 80 kg skim milk powder (8% w/w of entire final mix), 40 kg of maltitol (4.0% w/w of entire final mix), 40 kg inulin (4.0% w/w of entire final mix), 0.350 kg of steviol glycosides (0.035% w/w of entire final mix). It is believed that in general, it is preferable to add about 0-6% protein before pasteurization. Other flavouring components may also be introduced at this stage or reserved for later addition, for example masking agents, salts, citric acid, strawberry puree, cocoa powder, peanut butter, as may be required for the particular blend of ice cream being prepared.

All of the above ingredients are then brought to a temperature of pasteurization of about 63° C. to about 75° C., commonly 71° C. and kept at this temperature for 30 minutes.

The mix is then sent through a plate cooler for the mix to achieve a temperature of 2° C. to 5° C.

Following the preparation of the cooled second mix above, 142.5 kg of whey protein isolate (90% purity) (14.25% w/w of the entire final mix) The whey protein isolate is introduced by shear blending (with either inline shear blending or outline sheer blending) into the cooled second mix. Other methods of blending may also be used, although sheer blending is preferred. Color additives and flavoring components are then added as necessary.

The mix is then frozen using any type of ice cream machine that is permitted in ice cream and/or frozen desert manufacturing.

The ice cream is then cupped into our 500 ml cups and stocked into boxes. Each cup of 500 ml has 300 grams of product in it.

### EXAMPLE 4

### Preparation of a Frozen Desert No. 4 (Low Fat 3%)

In a pasteurization tank add 532.0 kg of water and 70 kg of 37% standardized unpasteurized cream. This accounts for 60.20% w/w of the entire final mix. The first mix is agitated until blended.

With a Tri-blender™ or sheer blender (or any other mixing apparatus) add 50 kg of erythritol (5.0% w/w of entire final mix), 3.5 kg of stabilizing agent (guar gum, locust bean gum, and carrageenan—0.35% w/w of the entire final mix), 20.0 kg of milk protein concentrate (70% purity) (2.0% w/w of entire final mix), 100 kg skim milk powder (10.0% w/w of entire final mix), 50 kg of maltitol (5% w/w of entire final mix), 80 kg inulin (8% w/w of entire final mix), 0.350 kg of steviol glycosides (0.035% w/w of entire final mix) It is believed that in general, it is preferable to add about 0-6% protein before pasteurization. Other flavouring components may also be introduced at this stage or reserved for later addition, for example masking agents, salts, citric acid, strawberry puree, cocoa powder, peanut butter, as may be required for the articular blend of ice cream being prepared.

All of the above ingredients are then brought to a temperature of pasteurization of about 63° C. to about 75° C., commonly 71° C. and kept at this temperature for 30 minutes. The mix is then sent through a plate cooler for the mix to achieve a temperature of 2° C. to 5° C.

Following the preparation of the cooled second mix above, 941.5 kg of whey protein isolate (90% purity) (9.415% w/w of the entire final mix) The whey protein isolate is introduced by shear blending (with either inline shear blending or outline sheer blending) into the cooled second mix. Other methods of blending may also be used, although sheer blending is preferred. Color additives and flavoring components are then added as necessary.

The mix is then frozen using any type of ice cream machine that is permitted in ice cream and/or frozen desert manufacturing.

The ice cream is then cupped into our 500 ml cups and stocked into boxes. Each cup of 500 ml has 300 grams of product in it.

### EXAMPLE 5

### Preparation of a Frozen Desert No. 5 (High Fat & Vitamins)

In a pasteurization tank add 398.05 kg of water and 258.00 kg of 37% standardized unpasteurized cream. This accounts for 65.605% w/w of the entire final mix. The first mix is agitated until blended.

With a Tri-blender™ or sheer blender (or any other mixing apparatus) add 55 kg of erythritol (5.5% w/w of entire final mix), 3.5 kg of stabilizing agent (guar gum, locust bean gum, and carrageenan—0.35% w/w of the entire final mix), 12.5 kg of milk protein concentrate (70% purity) (1.25% w/w of entire final mix), 80 kg skim milk powder (8% w/w of entire final mix), 30 kg of sugar (3% w/w of entire final mix), 60 kg inulin (6% w/w of entire final mix), 0.450 kg of steviol glycosides (0.045% w/w of entire final mix) It is believed that in general, it is preferable to add about 0-6% protein before pasteurization. Other flavouring components may also be introduced at this stage or reserved for later addition, for example masking agents, salts, citric acid, strawberry puree, cocoa powder, peanut butter, as may be required for the particular blend of ice cream being prepared.

All of the above ingredients are then brought to a temperature of pasteurization of about 63° C. to about 75° C., commonly 71° C. and kept at this temperature for 30 minutes.

The mix is then sent through a plate cooler for the mix to achieve a temperature of 2° C. to 5° C.

Following the preparation of the cooled second mix above, 102.5 kg of whey protein isolate (90% purity) (10.25% w/w of the entire final mix) The whey protein isolate is introduced by shear blending (with either inline shear blending or outline sheer blending) into the cooled second mix. Other methods of blending may also be used, although sheer blending is preferred. At this point, a liquid vitamin and mineral blend is added to the mix. Color additives and flavoring components are then added as necessary.

The mix is then frozen using any type of ice cream machine that is permitted in Ice Cream and/or frozen desert manufacturing.

The Ice Cream is then cupped into our 500 ml cups and stocked into boxes. Each cup of 500 ml has 300 grams of product in it.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A process for the preparation of a protein-fortified frozen dessert formulation comprising:
a) mixing a first mix comprising water and a source of fat;
b) mixing in said first mix a stabilizing agent, a sweetening agent, a first protein mix, to obtain a second mix;
c) pasteurizing said second mix;
d) cooling said second mix to produce a cooled second mix;
e) adding a second protein mix into said cooled second mix, before, after, or before and after step d);
f) ageing said cooled second mix to produce an aged mix;
g) freezing the aged mix to prepare said protein-fortified frozen dessert formulation,
wherein
said water is about 40-60% (w/w) of said aged mix,
said source of fat is about 0-20% (w/w) of said aged mix,
said stabilizing agent is about 0-1.5% (w/w) of said aged mix,
said sweetening agent is about 0-35% (w/w) of said aged mix,
said first protein mix is about 2-13% (w/w) of said aged mix,
said second protein mix is 2.5-25% (w/w) of said aged mix, and
said flavoring agent is 0-20% (w/w) of said aged mix.

2. The process of claim 1, wherein step b) further comprises mixing in a flavoring agent.

3. The process of claim 1, wherein step c) further comprises subjecting said second mix to two stage pressure homogenization.

4. The process of claim 1, wherein said source of fat includes a pasteurized cream, an unpasteurized cream, a biological cream, a processed cream, a coconut cream, a standardized cream, an unstandardized cream, a pasteurized milk, an unpasteurized milk, a milk fat solid, a coconut milk, a buttermilk, a buttermilk solids, a dairy based solid, a non-dairy based solid, a butter based fat, an omega fatty acids, a palm oil, a corn oil, and a rapeseed oil, or combinations thereof.

5. The process of claim 1, wherein said suitable stabilizing agents comprises gelatin, pectin, calcium chloride, lecithin, mono and diglycerides, monoglyceride derivatives, fatty acid derivatives, guar gum, gum arabic, tara gum, acacia, acetan, acetylated distarch phosphate, acetylated starch, acid-thinned starch, adipic starch, agar (agar-agar), agaropectin, agarose, algin, alginate, alginic acid, amidated pectins, amorphophallus, amylopectin, amylopectin starch, amylose, arabic, arabica, arabinogalactan, arabogalactan, arracacha, arrowroot, beet pulp, beta glucan, bevo, blood, british gum, cactus gum, carboxymethyether starches, carboxymethylcellulose, carboxymethylmethylcellulose, carboxymethyl starch, carob, caseins, caseinates, cassia, chitin, chitosan, clay, collagen, combretum, curdlan, cyclodextrin, cydonia, danish agar, dextran, dextrin, dulsan, distarch phosphate, ethylcellulose, ethylhydroxyethylcellulose, ethylmethylcellulose, eucheumas, ferlo, fibres, fibrinogen, flax seed, fucoidan, furcelleran, funoran, galactomannans, gatto, gelidium, gellan gum, ghatti, gigartinas, globulins, glucomannans, glues, gluten, gracilarias, guluronics, gummifera, hashab, hemicelluloses, high amylose starch, hoblobo, hydrogenated starch, hydroxyalkylcellulose, hydroxyalkyl starch, hydroxyethylcellulose, hydroxyethylmethylcellulose, hydroxypropylcellulose, hydroxypropylmethyl-cellulose, hydroxypropyl starch, hypnean, iridaeans, isinglass, karaya, karroo, kelp, keltzan, konjac, kordofan, lakee, lambda carrageenan, laminaran, larch, latex, linseed, locust bean gum, lupo, luposol, maltodextrin, mannan, mannoglucuronoglycans, mannuronics, maracuya, mesquite, methylcellulose, microcrystalline cellulose, mucilage, mucin, mung bean, okra, ovalbumins, oxidised starch, pea starch, pectic acid, plant exudates, plasma, porphyran, potato pulp, potato starch, pregelatinized starches, proatrim, propylated starch, propylene glycol alginate, prosopsis seed, prosopsis, exudate, protopectins, prowashonupana barley, pulcherima, pullulan, psyllium, pyrodextrins, quince, quince seed, ramalin, rhamsam, rice products, st. johns bread, salabreda, sandra beida, schizophyllan, scleroglycan, seaweed powders, semen cydonia, senna, seyal, sorghum, soy protein, sterculia, suakim, succinoglycan, sunflower pectin, sunt, tahl, tahla, tamarind seed, tamarind kernel, taminda, tapioca, tara, tragacanth, undaria, verek, wattles, waxy maize, waxy rice, waxy sorghum, wheat products, whey protein, xyloglucan, yeast cell walls, gelatin, iota carrageenan, kappa carrageenan, a pectin, a powdered cellulose, sodium alginate, xanthan gum, and combinations thereof.

6. The process of claim 1, wherein said sweetening agent comprises, glucose, fructose, sucrose, xylitol or any other polyalchohol such as arabitol, erythritol, glycerol, hydrogenated starch hydrolysates (HSH), isomalt, lactitol, maltitol, mannitol, sorbitol, ethylene glycol, threitol, ribitol, galactitol, fucitol, iditol, inositol, volemitol, maltotrital, maltotetraitol, polyglycitol, mongrosides, as well as other sugar alternatives such as aspartame, agave, stevia, coconut sugar, date sugar, acesulfame K, cyclamate, saccharin, sucralose, or combinations thereof.

7. The process of claim 1, wherein said first or said second protein mix comprises whey protein, a milk protein, a casein, an albumin, a vegetable protein, soy protein, a whey protein concentrate, a whey protein isolate, a hydrolyzed whey protein, a milk protein concentrate, a milk protein isolate, a hydrolyzed milk protein, a soy protein concentrate, a soy protein isolate, a hydrolyzed soy protein, a heat stable whey protein, a whey concentrate, an egg white protein, a rice protein, a pea protein, a hemp protein, an insect based protein powder, and combinations thereof.

8. The process of claim 1, wherein said flavoring agents comprise a cocoa powder, a chocolate, a chocolate chips, a flavor providing powder, a liquid flavor, a maple syrup, a maple sap, a fruit flavoring, a vanilla flavor, a caramel, peanut butter, bubble-gum, nuts, fruits, vegetables, cookies, brownies, pie crust pieces, wafer pieces, sugar cone pieces; cookie dough; candies; chocolate bar pieces;
crunches, jams, purees, and combinations thereof.

9. The process of claim 8, wherein said fruit flavoring comprises orange, apple, grapefruit, pineapple, strawberry, raspberry, cranberry, lime, lemon, grape, peach, cherry flavor, and combinations thereof.

10. The process of claim 1, wherein step b) is with a high sheer mixer, or a high speed tank blender.

11. The process of claim 1, wherein step b) is at from about 35° C. to about 60° C.

12. The process of claim 1, wherein step c) of pasteurizing is at from about 70° C. to 71° C. for 30 minutes.

13. The process of claim 3, wherein said two stage pressure homogenization comprises a first stage at from about about 6.9 Mpa to about 17.2 Mpa, and a second stage at 3.4 Mpa to about 6.9 Mpa.

14. The process of claim 3, wherein said two stage pressure homogenization comprises a first stage at from about about 10.3 Mpa to about 17.2 Mpa, and a second stage at 3.4 Mpa to about 6.9 Mpa.

15. The process of claim 3, wherein said two stage pressure homogenization comprises a first stage at from about about 13 Mpa to about 14 Mpa, and a second stage at 3.4 Mpa to about 6.9 Mpa.

16. The process of claim 1, wherein step d) of cooling is to about 2° C. to about 5° C.

17. The process of claim 1, wherein step f) of ageing is for about 2 to about 10 hours.

18. The process of claim 1, wherein said second protein mix, said flavoring agent, or both are provided as pre-pasteurized.
